(19) United States
(12) Patent Application Publication
(10) Pub. No.: US 2008/0033968 A1
(43) Pub. Date: Feb. 7, 2008

(54) Methods and apparatus for input specialization

(76) Inventors: Dennis A. Quan, Quincy, MA (US); Eric David Perkins, Boston, MA (US); Chetan R. Murthy, Cambridge, MA (US); Moshe Morris Emanuel Matsa, Cambridge, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/501,216

(22) Filed: Aug. 7, 2006

(51) Int. Cl. G06F 7/00; G06F 17/30

(52) U.S. Cl. 707/100; 707/3

(57) ABSTRACT

A program specializer employs input specialized data structures by generating an input specialized definition of a set of data elements, and parsing an application program to identify data element references to data elements in the generated input specialized definitions of data elements. A data structure generator responsive to the program specializer computes an input specialized definition corresponding to each of the identified references data element references, and a parser in the program specializer replaces or rewrites the identified data element references with the corresponding input specialized definition. Computing the input specialized definition includes determining an index for offset indirection, therefore having offset references to members of the data element, such that the data element members are operable for indexed references by the resulting input specialized application program.

### BACKGROUND

In conventional Extensible Markup Language (XML) based applications, a typical first step in an XML processing application is to read in an XML document from disk (or the network) into memory. Most of the standards for XML processing operate on an abstract model of the document in which the document is modeled as a set of nodes linked together with two fundamental, bidirectional relationships, parent/child, and previous-sibling/next-sibling. Traversal of these conventional linkages to locate specific nodes is accomplished by so-called QName traversals (i.e. get the next sibling named “foo”, or the first child named “bar”), as the model is meant to be generalized for any XML vocabulary. Note that in most conventional models, attributes are handled specially, and are not considered children—or siblings—because of their special, unordered semantics. The basic conventional access pattern, however, remains the same. The W3C (World Wide Web Consortium, as is known in the art) standard Document Object Model (DOM) provides a standard example of this model both in abstract, and in concrete implementation.

While this conventional DOM model provides a useful, general purpose, abstraction for programmatic access to XML data, as a concrete implementation of the in-memory model for XML data, it may present obstacles to performance. In particular, the flexibility of the model, with four-way linkages, and dynamic, QName lookup, makes any direct implementation of the conventional model heavyweight. Furthermore, the QName-based access pattern presents a performance problem as the sequence of nodes in a given relation (child, parent, previous, next) are traversed, and dynamically compared with the requested QName.

### SUMMARY

In conventional XML based systems, a document object model (DOM) provides a powerful and flexible mechanism to specify XML data elements and allow the data elements to be employed by application programs. However, conventional XML configurations suffer from the shortcoming that data structures generated from DOM based elements tend to generate complex pointer arrangements with multiple levels of indirection. Such complex pointer structures, while powerful at performing dynamic runtime adaptation to different data types, often incur substantial overhead for traversing tree nodes and matching node names to identify particular data objects. It would be beneficial to employ XML definitions, such as DOM based definitions, without incurring large memory requirements and extended traversal and matching operations during runtime. As employed herein, the term DOM is meant to imply a set of data structures for representing XML in memory. The resulting DOM based definitions are therefore operable for processing such as Qname traversal and/or processing via the above indicated pointer structures.

In the context of a compiled XML processing program, a lighter-weight data structure, with more efficient access capabilities is desired. A data structure, specialized to the known shape of the data, such as a c struct, or c++/Java class is ideal from a performance and memory-use perspective. Members of the data structure can be accessed by offset indirection, instead of list traversal. In other words, the structure is organized such that specific children are located at specific offset in the data record. This offset is known statically at compile time, so navigation from one node to one of its specific children involves only incrementing a pointer by this known value, and in some cases performing a pointer indirection. These operations are typically highly efficient on most native machine architectures. Further, the relationships and names of the nodes are implied by the structure, rather than interpreted dynamically. That is to say, the name of a given node is encoded statically in its type, and therefore known statically at compile time. This eliminates any code required to dynamically retrieve its name, as well as any code used to operate on the name, such as a comparison against other known values. Similarly, information about a node's closer relatives may be surmised from the overall type hierarchy.

Procedures for derivation of such strongly-typed concrete data structures from abstract typing systems for XML, such as W3C XML Schema, are well known; gSOAP and JAX_RPC are two common examples. These structures are not, however, strictly suitable for the various high-level, dynamically-typed languages for processing of XML, as they lack the multi-way linkages of the abstract document nodes, and are currently therefore limited to use as foreign representations of XML for low-level, procedural programming languages in which XML is not a part of the usual type-system.

Accordingly, configurations herein substantially overcome the above described shortcomings by providing input specialized data structures derived from DOM based definitions, and computing offset indirection references for data elements in an application program. The offset indirection references provide a deterministic index to a data element derived from the DOM based definitions, without performing extensive runtime string matching or other computationally intensive operations. A program specializer receives a set of offset indirection references corresponding to a DOM based definition of data elements. In the exemplary configuration, the application program may be an XML program having data elements defined in XSLT and employing Xpath references. A data structure generator generates the input specialized definitions for the data elements referenced by the application program. The program specializer invokes the generated input specialized definitions, and replaces, or rewrites, the DOM based data element references in the application program. The resulting input specialized program invokes data elements operable to access data structure members by offset indirection, rather than list traversal. In this manner, the runtime burdens of conventional list traversal and node name matching are shifted to compile time generation of input specialized definitions, thus allowing data element references via an offset indirection index, rather than resource intensive traversals of complex data structures.

Configurations here depict an approach to specialize XML processing programs, written in languages (such as XSLT) that operate on an abstract node model similar to the general description above, such that they are rewritten to operate on strongly typed, input-specialized data structures which are derived from an XML type definition language (such as XML Schema). This approach allows programs written with these high-level languages to perform comparably to programs written in low-level languages against efficient, task-specific data structures.

The process depends on two tools for XML data specialization. First, a set of data structure definitions (e.g. Java classes) is derived from the type definitions (e.g. XML Schema) which define the input XML. This can be done using any suitable mapping, or a custom mapping that is similar in implementation. The key properties of the input-specialized data structures are that they represent the names and interrelationships of the data in their structure, and maintain only the unidirectional, named child relationship. The second component employs a schema-aware, deserializing parser which can efficiently populate these data structures. Again several alternatives exist, including the widely available gSOAP framework, which generates efficient, compiled deserializers for this task.

Using the input-specialized type system, and working progressively through the generic, node-oriented program, configurations herein translate the operations, initially defined over nodes, and their multi-way access patterns to operations over the input-specialized data structures, using only the unidirectional, named accessors. Along the way information derived from the data structure (and via it, from the originating schema types) is incorporated into the program to increase efficiency. For example, by imposing the strongly-typed input to the program it may be possible to determine that certain expressions must, when applied to the relevant input-specialized type, always produce the same result. In that case, their runtime evaluation can be statically eliminated. In the case where the expression is used in a code branch (such as in a switch, or if-then-else), whole sections of code may thus be eliminated.

The result of this automated translation is a program written to operate on a task-specific, input-specialized data structure. When compiled into an executable, this program will achieve performance comparable to a well-tuned program written by hand to operate on those data structures.

In further detail, the method of processing an input specialized data structure as defined herein includes generating an input specialized definition of a set of data elements, and parsing an application program to identify data element references to data elements in the generated input specialized definitions of data elements. A data structure generator computes an input specialized definition corresponding to each of the identified data element references, and a program specializer replaces or rewrites the identified data element references with the corresponding input specialized definition. Computing the input specialized definition includes determining an index for offset indirection, therefore having offset references to members of the data element, such that the data element members are operable for indexed reference by the resulting input specialized application program.

Alternate configurations of the invention include a multiprogramming or multiprocessing computerized device such as a workstation, handheld or laptop computer or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a computer-readable medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM or RAM or PROM chips, field programmable gate arrays (FPGAs) or as an Application Specific Integrated Circuit (ASIC). The software or firmware or other such configurations can be installed onto the computerized device (e.g., during operating system or execution environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram of prior art XML data element definition and processing by a conventional XML application program;

FIG. 2 is a context diagram of an XML environment suitable for use with configurations disclosed herein

FIG. 3 is a flowchart of input specialized data structure processing performable by configurations herein

FIG. 4 is a block diagram of input specialized data structure processing as defined herein; and

FIGS. 5-8 are a flowchart of generating an input specialized application program using the system of FIG. 4.

### DETAILED DESCRIPTION

The disclosed configurations depict a process of input specialization that begins with a program written against the abstract XML data model described above—or any suitable data model with the above-described characteristics, such as the XPath data model—and a set of input-specialized data structures, which may be derived from an XML type definition language, such as XML Schema or other suitable language. The process is not limited to any particular such abstract model, or any particular set of concrete data structures, provided that the abstract model conforms to the general description of the node relationships above (notably four-way inter-relationships, and QName lookup), and that the concrete input-specialized data structures conform to the corresponding general description above (notably unidirectional relationships, and implied structure and naming). In an exemplary configuration of the method, we will refer to the canonical example of an XSLT program (which uses the XPath data model), being specialized to a set of Java classes, derived from an XML Schema (such as those produced by the mappings of JAX-RPC).

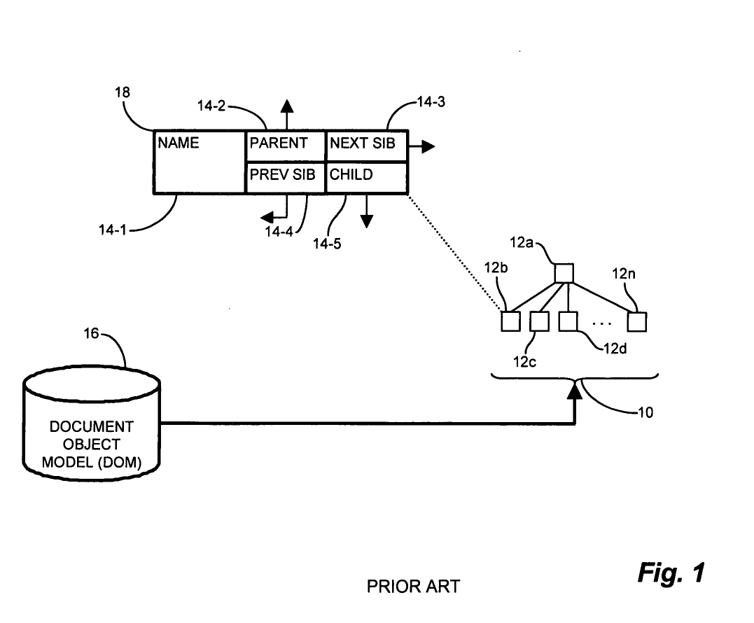

FIG. 1 is a diagram of prior art XML data element definition and processing by a conventional XML application program. Referring to FIG. 1, conventional XML processing mechanisms generate a hierarchical data structure (tree structure) 10 including a plurality of nodes 12a-12n, each representing a data element 18. A document object model (DOM) 16 is a repository for conventional data elements 18 defined in the tree 10, and is employed to generate a set of XML type definitions 15, also known as a schema. The data element 18 includes attributes 14-1 . . . 14-5 (14 generally) indicative of the links to other data elements 18 in the tree 10, thus defining the conventional tree structure 10. The conventional fields 14 include at least a node name 14-1, a parent pointer 14-2, a child pointer 14-5, a next sibling pointer 14-3 and a previous sibling 14-4. Other fields 14 may be included and define other fields of the data element 18. Therefore, conventional processing of DOM based tree structures 10 includes traversal of the tree structure 10 via the attributes 14-1 . . . 14-5. Further, conventional manipulation of the tree structure incurs processing with respect to each of at least five (14-1 . . . 14-5) attributes of the tree structure 10, and typically involves multiple “hops,” or traversal of individual nodes, for accessing the conventional data elements in the tree.

In contrast, in configurations herein, given a set of input-specialized data structures, and a mechanism by which to build them from an input XML document, the first step in the specialization process is to produce an in-memory representation of the program (in XSLT also called a stylesheet), where the input is assumed to be a generic data structure such as the DOM, or any other which closely models the generic abstract model of the program. The program is represented with an abstract syntax tree (AST), where the functions (in XSLT these correspond to templates) all take one or more parameters of the generic node type, and contain a body which is the expression for the function's result in terms of its parameters. In XSLT, templates all take an implied parameter, which is the current node. In the AST, these implied parameters are made explicit. Furthermore, XSLT supports a calling convention, apply-templates, in which the template to be called is determined by comparing the current node to a match pattern associated with a whole set of templates. In the AST, this is can be represented explicitly as a function in which the match patterns of the relevant templates are rewritten as Boolean-valued XPath expressions indicating whether the current node is matched. These expressions are evaluated in a conditional loop, whose branches contain explicit calls to their matched template. In languages other than XSLT, processing of similarly implied constructs will be performed to make the AST a simple, explicit program.

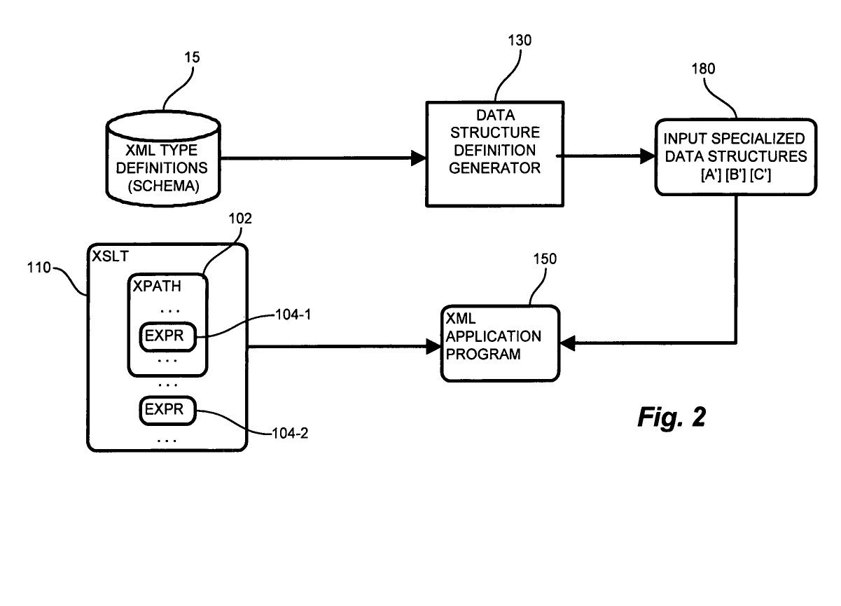

FIG. 2 is a context diagram of an XML environment suitable for use with configurations disclosed herein. Referring to FIG. 2, in a particular configuration, a style sheet including DOM derived definitions is developed as an XSLT document 110. The XSLT document 110 includes XPATH definitions 102 operable for processing as an XML based document, as is known to those of skill in the art. Configurations herein employ a data structure definition generator 130 to generate an input specialized definition of a set of data elements 120-1, 120-2 (120 generally) from DOM based definitions 104-1 . . . 104-2 (104 generally) in the style sheet 110. Alternatively, other DOM based or XML definitions may be employed. According to configurations herein, discussed further below, the data structure generator, or input specialized definition generator 130, generates a set of input specialized data elements 180 for use by the application program 150.

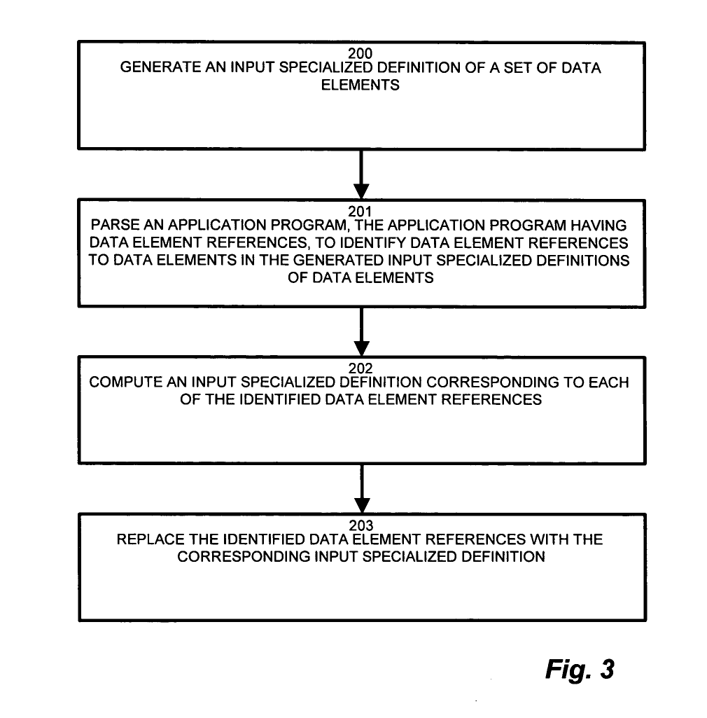

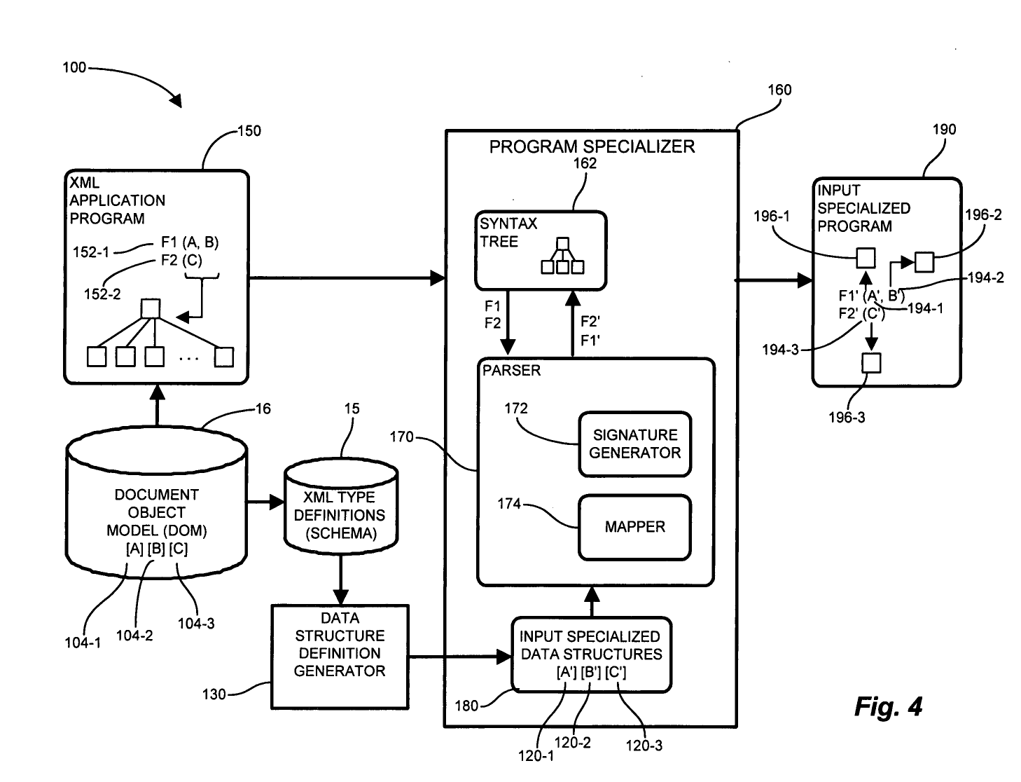

FIG. 3 is a flowchart of input specialized data structure processing performable by configurations herein. Referring to FIGS. 1-3, the method of processing markup data using an input specialized data structure 120 as disclosed herein includes, at step 200, generating an input specialized definition of a set of data elements, and parsing the application program 150 to identify data element references to data elements in the generated input specialized definitions of data elements, as depicted at step 201, typically employed in procedure/function call parameters in the application program 150 (FIG. 4). The data structure definition generator 130 computes a set of input specialized definitions 180 corresponding to each of the identified data element references 104, as shown at step 202, and a parser 170 (FIG. 4) replaces the identified data element references with the corresponding input specialized definition 120, as disclosed at step 203.

The process of program specialization begins at the entry point (or points) to the program 150. In XSLT, this is the initial invocation of the apply-templates function with the root of the document as the current node. Specialization begins at this call, by specifying that the root node is of the type corresponding to the document-root's representation in the input-specialized data structures 180.

Each call to an input-specializable function in the AST 162 is annotated with a new, input-specialized type signature, containing the input-specialized types 120 of each of the arguments 104. A complete copy of the called function F1, F2 is made for every unique calling signature, and the body expression of that function is recursively rewritten in terms of operations over the input-specialized data structures, at each step annotating the program with the calculated input-specialized type of each expression. When a call to another function is encountered, the input-specialized call signature is calculated, and the corresponding specialized copy of that function is queued for rewriting.

For each specialized copy of a function, the value expression is recursively rewritten in terms of expressions that operate on the specialized types 120. For example, an expression which, in the original version A-C, access an input node's child relation 14-5 with a given QName will be rewritten in terms of operations which access the appropriately named child field of the input-specialized type 120. Similarly, the input-specialized type 120 of every expression is calculated with reference to the original expression, and the input-specialized types of its arguments. Thus, for example, the type of the above child expression is determined to be the type of the named member in the argument's input-specialized structure. This process is carried out recursively through the AST tree 162, such that the resulting copy of the function is composed only of operations over the input-specialized types 120.

FIG. 4 is a block diagram of input specialized data structure processing as defined herein. Referring to FIG. 4, an application program 150 employing DOM 104 based references is receivable by a program specializer 160. The application program 150 includes function invocations F1 and F2 152-1 . . . 152-2 respectively (152 generally), that include the data element references 104-1 . . . 104-3 for A, B and C, respectively. The program specializer 160 receives the application program 150 in an abstract syntax tree (AST) 162. Also employing the DOM 16 definitions is the data structure generator 130, that generates input specialized data structures 180 derived from the schema definitions A, B and C (104). A parser 170 includes a signature generator 172 and a mapper 174.

The parser 172 processes the syntax tree 162 to identify function invocations F1 and F2 including data element references included in the input specialized data structures 180. The mapper 174 identifies the input specialized data structures A′, B′ and C′ (120) corresponding to the data element references A, B and C (104) from the application program 150. The signature generator 172 employs the mapped data elements A′ B′ and C′ to replace the function invocations F1 and F2 with the input specialized function references (signatures) F1′ and F2′ 192 in the output application program 190 including the input specialized calls 192. Accordingly, the input specialized data elements 1941.194-3 are operable to access the corresponding data item 196-1.196-3 via a single offset indirection 198, thus avoiding an iteration of pointer references and name matching typically associated with DOM based references in an application program.

In the simplest content models, where the content is just a sequence of elements, named child expressions will reference one member of the input-specialized data structure. In more complicated cases, it may be necessary to reference several members. In this case, a more complex expression will be used to retrieve all of the relevant children, and gather them into a result set. These results might be encoded in a variety of ways, including lists or arrays, but also possibly tuples or even lambda expressions which, when evaluated, return the desired result—or, of course a combination of any of these representations. In particular, more complicated schemes, perhaps involving unions, or union-like structures, may be desirable when all of the result nodes are not of the same type. For configurations including XML Schema, all identically named children are restricted to be of the same type, and so in many cases, a simple list or array will suffice.

Rewriting of simple expressions involving child relations is straight-forward; an expression which accesses a named child of an input node is rewritten to access the named member or members of that node's input-specialized type. However, in the case of the other relations (parent, next and previous)—or extended relations derived from them (e.g. XPath's ancestor axis)—the conversion may employ additional processing. Since the input-specialized types do not include accessors for these other relationships, support for such expressions must be achieved by saving references to parent nodes further up the expression tree, while references to those nodes are still in scope. In particular, this means that the actual type used for any node in the expression is not just the type stipulated by or derived from the calling context, but is, in fact a collection of that node, and any of its ancestor nodes which may be required by dependent expressions. This collection could be implemented in a variety of ways, for example, as a tuple, or a list. Within a function, these dependencies are resolved while evaluating the expressions to determine their input-specialized types. For example, if the result of a particular expression is used in a subsequent expression that would require its parent (or more distant ancestor), then the type of that expression is augmented with the relevant parent/ancestor node to reflect the additional dependency. These dependencies are propagated up the input-specialized type annotations on the expression tree for the function during regular function specialization. For ancestor dependencies which cross function boundaries, the propagation is performed across the whole (potentially recursive) function call stack repeatedly until the full set of dependencies is resolved. As a result, all of the functions in the call-stack will be modified to prepare for such back-references. For example, if a function takes as an argument a given node, and in its value expression, accesses its grandparent node, then an annotation is made on that function argument, stating that the node must be passed in with its two ancestors; furthermore, any variable in another function that supplies that variable is similarly annotated as needing its two ancestors to be remembered. If such a variable X is the result of a child step from yet another variable Y, then Y is annotated as needing only one of its ancestors, and so on. The process of “remembering” means that, whereas in the original code, a variable X might require a single value to be passed, the new code might require 2 or more values to be passed along in the X variable, depending on the number of ancestors that needs to be remembered. Expressions for siblings are handled similarly, as that access is made via the parent node.

The choice of representation of ancestor nodes may vary according to the needs of the program. For example, if the input-specialized type system is recursive, it may not be possible to bound the number of ancestors required for a given function (especially if that function is also recursive). In such a case, the tuple representation may not be appropriate, and a list or other representation will be preferred. This does not present an insurmountable problem, however, since the recursion is easily detected during specialization analysis, and dealt with accordingly.

During expression rewriting, application of the input-specialized type system to the original, generically typed program may render some branches of the program unreachable. This can be a source of significant performance improvement, as the runtime check for those branches may be eliminated statically. A good example of how this operates can be seen in the implied apply-templates function of an XSLT program. Typical usage of apply templates will select a particular named descendant of the current node, and apply templates on it. With the input-specialized type of that node (and thus its name) known, the number of template match expressions that can possibly evaluate to true is greatly reduced (since most of the templates will match on a distinct name). Indeed in the most common usage, where there is only one match pattern that accepts the given named node, the specialized apply-templates function for that call will be optimized down to a direct call into a specific template, a so-called partial evaluation operation.

Once all of the reachable functions in the program are specialized, the unused, original copies of the functions are removed from the AST. The result is complete version of the program, rewritten to operate on the efficient, lightweight, input-specialized data structures. When execution code is generated for this AST, it is coupled with the deserializing parser described above, to produce a fully functional version of the program that leverages the superior memory and access characteristics of the specialized data structures to achieve significant performance improvement over the generic version. Thus an executable is automatically generated from the high-level dynamically typed source, which has comparable performance and memory characteristics of a low-level program written against task-specific data structures.

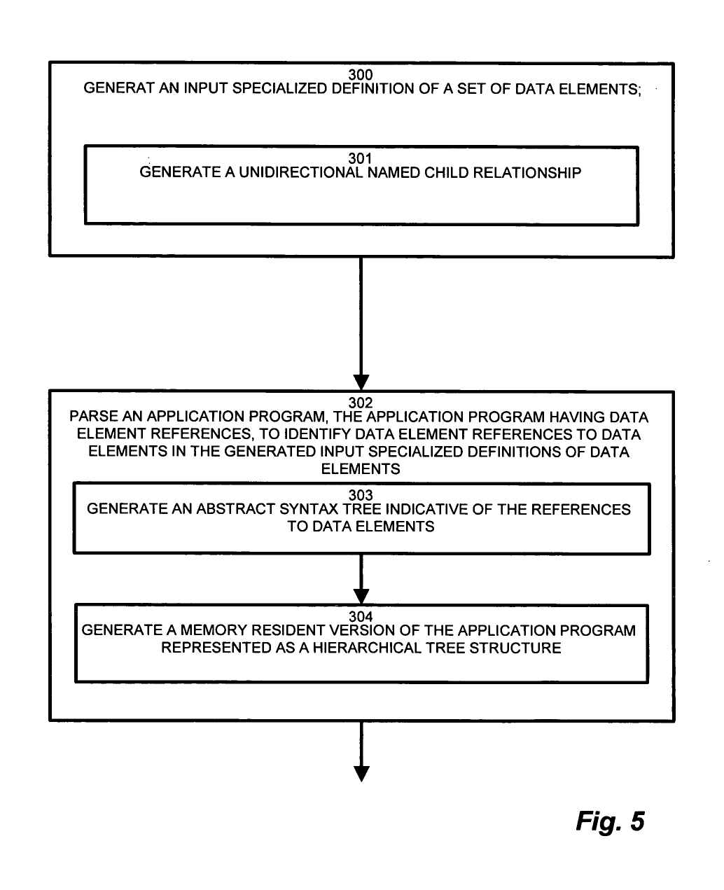

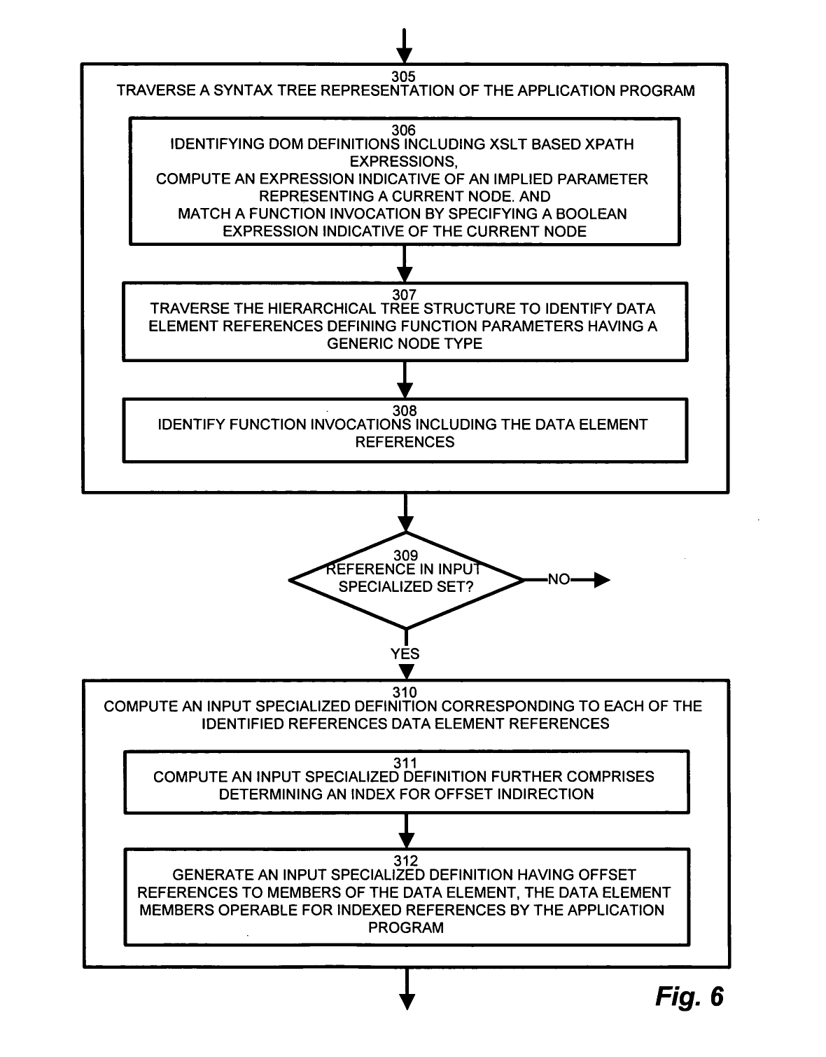

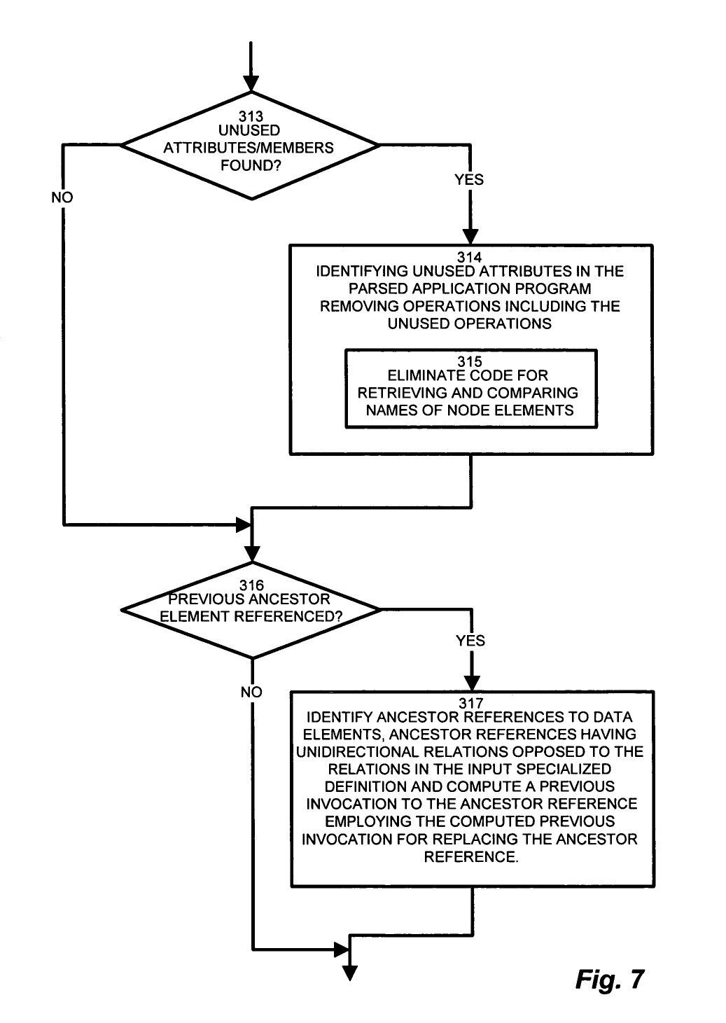

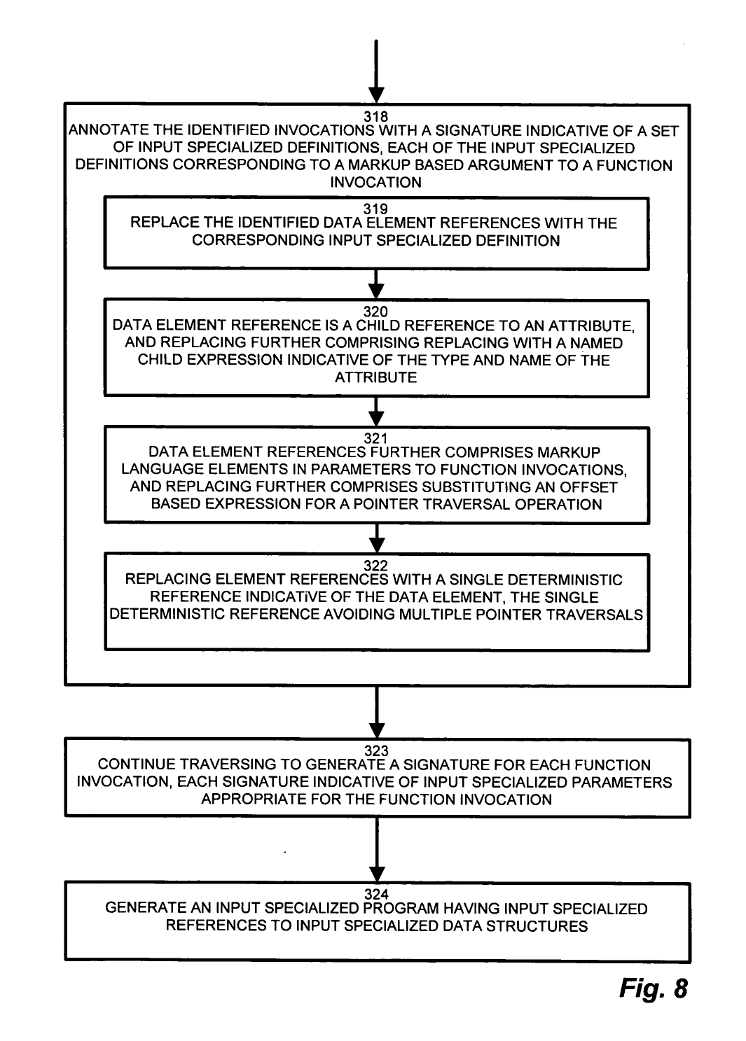

FIGS. 5-8 are a flowchart of generating an input specialized application program using the system of FIG. 4. The disclosed flowchart shows an exemplary manner of a particular arrangement implementing the method discussed above, and is not intended to limit the above functionality in any way. Referring to FIGS. 4-8, at step 300, the method of processing an input specialized data structure according to configurations herein includes generating an input specialized definition 120 of a set of data elements 180. In the exemplary configuration, generating an input specialized definition further includes generating a unidirectional named child relationship, as depicted at step 301. This unidirectional structure need not be linked in both directions to each parent and sibling, as in conventional DOM based structures.

The parser 170 in the program specializer 160 parses the application program 150 to identify data element references 104 to data elements in the generated input specialized definitions of data elements 120, as shown at step 302. In the arrangement shown, parsing includes generating an abstract syntax tree 162 indicative of the references 104 to data elements, as depicted at step 303. Building the abstract syntax tree (AST) 162 includes generating a memory resident version of the application program 150 represented as a hierarchical tree structure (such as the AST 162), as shown at step 304. The AST or other memory resident structure identifies the data element references to be replaced with input specialized data element references 120.

The parser 170 traverses the syntax tree 162 representation of the application program, as depicted at step 305. During the traversal, the parser identifies DOM references including XSLT based XPath expressions, responsive to input specialization as defined herein. Such expressions are those replaceable by one or more of the input specialized data structures 120. The signature generator 172 computes an expression indicative of an implied parameter representing a current node, and the mapper 174 matches a function invocation by specifying a Boolean expression indicative of the current node, as depicted at step 306. Thus, the program specializer 160 traverses the hierarchical tree structure 162 to identify data element references 104 defining function F1, F2 parameters having a generic node type, as disclosed at step 307. The traversal therefore identifies function invocations 152 including the data element references 104, as depicted at step 308.

For each data element reference 104 traversed, a check is performed to identify if it is encompassed with a complementary input specialized data structure 120 in the input specialized data structures 180 generated previously, as shown at step 309. If so, then the signature generator 172 computes an input specialized definition F1′, F2′ corresponding to each of the identified data element references, as depicted at step 310. In the exemplary configuration, this includes, at step 311, determining an index for offset indirection, as shown at step 311, and thus further involves generating an input specialized definition 120 having offset references to members of the data element A-C, as disclosed at step 312, such that the data element A-C members are operable for indexed references 194 by the application program 190.

A check is performed, at step 313, to identify unused data members and/or attributes of the input specialized definition 120. As indicated above, the DOM based definitions tend to be over inclusive, and therefore may include elements unused in a particular arrangement. If unused members are found, then parsing invokes partial evaluation, partial evaluation including identifying unused attributes in the parsed application program, and removing operations including the unused operations, as depicted at step 314. Such removal eliminates code for retrieving and comparing names of node elements, as shown at step 315.

Another check is performed for references to ancestor nodes corresponding to parent node traversals, as shown at step 316. As indicated above, the program specializer operates on a unidirectionally linked structure that may be linked only in the child node direction. Accordingly, such parsing further includes identifying ancestor references to data elements 104, in which the ancestor reference has unidirectional relations opposed to the relations in the input specialized definition (i.e. attempting to get a parent in a child-only linking), and computing a previous invocation to the ancestor reference. The parser 170 employs a computed previous invocation for replacing the ancestor reference, as depicted at step 317. In other words, at some point in the traversal, the now sought parent node has been referenced, at which point the location is stored for future ancestor references.

Having identified appropriate references for input specialization, the parser 170 annotates the identified invocations with a signature indicative of a set of input specialized definitions 120, each of the input specialized definitions 120 corresponding to a markup based argument A-C of a function invocation F1, F2, as shown at step 318. This annotation includes replacing the identified data element references 104 with the corresponding input specialized definition 120, as depicted at step 319. In particular instances, the data element reference 104 may be a child reference to an attribute, and replacing further includes replacing with a named child expression indicative of the type and name of the attribute, as depicted at step 320. Such a named child attribute is indicative of type and name by virtue of the location, or offset, in the reference, rather than requiring a traversal and name matching. The data element references may define markup language elements in parameters to function invocations, in which replacing further includes substituting an offset based expression for a pointer traversal operation, as shown at step 321. Therefore, such replacing or rewriting involves replacing element references with a single deterministic reference 194 indicative of the data element 196, as depicted at step 322, such that the single deterministic reference 194 avoids multiple pointer traversals, i.e. is an offset reference, rather than a pointer to a more complex pointer structure with multiple levels of indirection and node matching.

The parser 170 continues traversing to generate a signature for each function invocation 104, such that each signature is indicative of input specialized parameters 120 appropriate for the function invocation, as shown at step 323. Upon completion, the program specializer 160 generates an input specialized program 190 having input specialized references 194 to input specialized data structures 196, as depicted at step 324.

The disclosed configurations may result in large amounts of new code, some parts of which are repetitive, some parts of which have dangling references, and many parts of which can be optimized. Configurations herein optimize this code using partial evaluation in order to bring the code size back down to the approximate size it was prior to input specialization.

Those skilled in the art should readily appreciate that the programs and methods for processing markup data using an input specialized data structure as defined herein are deliverable to a processing device in many forms, including but not limited to a) information permanently stored on non-writeable storage media such as ROM devices, b) information alterably stored on writeable storage media such as floppy disks, magnetic tapes, CDs, RAM devices, and other magnetic and optical media, or c) information conveyed to a computer through communication media, for example using baseband signaling or broadband signaling techniques, as in an electronic network such as the Internet or telephone modem lines. The disclosed method may be in the form of an encoded set of processor based instructions for performing the operations and methods discussed above. Such delivery may be in the form of a computer program product having a computer readable medium operable to store computer program logic embodied in computer program code encoded thereon, for example. The operations and methods may be implemented in a software executable object or as a set of instructions embedded in a carrier wave. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and method for processing markup data using an input specialized data structure has been particularly shown and described with references to embodiments thereof, it will be understood by those skilled in the art that various changes in form and details may be made therein without departing from the scope of the invention encompassed by the appended claims.

What is claimed is:

1. An encoded set of processor based instructions for implementing a method of processing an input specialized data structure comprising:
obtaining an input specialized definition of a set of data elements;
parsing an application program, the application program having data element references, to identify data element references to data elements in the generated input specialized definitions of data elements;
computing an input specialized definition corresponding to each of the identified data element references; and
replacing the identified data element references with the corresponding input specialized definition.

2. The method of claim 1 wherein computing an input specialized definition further comprises determining an index for offset indirection.

3. The method of claim 2 further comprising generating an input specialized definition having offset references to members of the data element, the data element members operable for indexed references by the application program.

4. The method of claim 3 wherein the data element reference is a child reference to an attribute, and replacing further comprising replacing with a named child expression indicative of the type and name of the attribute.

5. The method of claim 4 wherein replacing the identified references further comprises generating an input specialized program having input specialized references to input specialized data structures.

6. The method of claim 1 further comprising
traversing a syntax tree representation of the application program;
identifying function invocations including the data element references;
annotating the identified invocations with a signature indicative of a set of input specialized definitions, each of the input specialized definitions corresponding to a markup based argument to a function invocation; and
continuing traversing to generate a signature for each function invocation, each signature indicative of input specialized parameters appropriate for the function invocation.

7. The method of claim 6 wherein the data element references further comprises markup language elements in parameters to function invocations, and replacing further comprises substituting an offset based expression for a pointer traversal operation.

8. The method of claim 7 wherein generating an input specialized definition further comprise generating a unidirectional positionally specific child relationship.

9. The method of claim 1 wherein parsing includes generating an abstract syntax tree indicative of the references to data elements, further comprising
generating a memory resident version of the application program represented as a hierarchical tree structure;
traversing the hierarchical tree structure to identify data element references defining function parameters having a generic node type.

10. The method of claim 9 wherein generating an abstract syntax tree further comprises:
identifying DOM definitions including XSLT based XPath expressions;
computing an expression indicative of an implied parameter representing a current node; and
matching a function invocation by specifying a Boolean expression indicative of the current node.

11. The method of claim 5 wherein parsing further comprises
identifying ancestor references to data elements, ancestor references having unidirectional relations opposed to the relations in the input specialized definition;
computing a previous invocation to the ancestor reference; and
employing the computed previous invocation for replacing the ancestor reference.

12. The method of claim 11 wherein parsing further comprises partial evaluation, partial evaluation including
identifying unused attributes in the parsed application program; and
removing operations including the unused operations.

13. The method of claim 12 wherein the replacing eliminates code for retrieving and comparing names of node elements.

14. The method of claim 13 further comprising replacing element references with a single deterministic reference indicative of the data element, the single deterministic reference avoiding multiple pointer traversals.

15. A program specializer for processing an input specialized data structure comprising:
data structure generator for generating an input specialized definition of a set of data elements;
a parser for parsing an application program to identify data element references to data elements in the generated input specialized definitions of data elements;
a signature generator computing an input specialized definition corresponding to each of the identified references data element references; and
a mapper operable to replace the identified data element references with the corresponding input specialized definition, the mapper operable to generate an input specialized definition having offset references to members of the data element, the data element members operable for indexed references by the application program.

16. A computer program product having a computer readable medium operable to store computer program logic embodied in computer program code encoded thereon for processing an input specialized data structure comprising:
computer program code for generating an input specialized definition of a set of data elements;
computer program code for parsing an application program to identify data element references to data elements in the generated input specialized definitions of data elements;
computer program code for computing an input specialized definition corresponding to each of the identified references data element references; and
computer program code for identifying function invocations including the data element references;
computer program code for annotating the identified invocations with a signature indicative of a set of input specialized definitions, each of the input specialized definitions corresponding to a markup based argument to a function invocation; and
computer program code for continuing traversing to generate a signature for each function invocation, each signature indicative of input specialized parameters appropriate for the function invocation; and
computer program code for replacing the identified data element references with the corresponding input specialized definition.

17. The method of claim 5 wherein the input specialized program is operable to be populated via XML at runtime.

18. The method of claim 1 wherein the input specialized program is then optimized via partial evaluation in order to reduce the code size down a substantially similar size as the application program.
